(19) United States
(12) Patent Application Publication
(10) Pub. No.: US 2026/0326086 A1
(43) Pub. Date: Oct. 22, 2026

(54) FRAGRANCE-CONTAINING GRANULES FOR ANIMAL LITTER

(71) Applicant: INTERNATIONAL FLAVORS & FRAGRANCES INC., New York, NY (US)

(72) Inventors: Franklin PRINGGOSUSANTO, Union Beach, NJ (US); Joseph BRAIN, Union Beach, NJ (US)

(21) Appl. No.: 19/100,469

(22) PCT Filed: Jul. 26, 2023
(86) PCT No.: PCT/US2023/028725

§ 371 Date: Jan. 31, 2025

(30) Foreign Application Priority Data
Aug. 9, 2022 (EP) 22189486.8

(51) Int. Cl. B01J 20/28; A01K 1/01

(52) U.S. Cl. CPC B01J 20/28016; B01J 20/28004; B01J 20/28011; A01K 1/0107

(57) ABSTRACT

This disclosure relates to a fragrance-containing granule that includes, by weight based on the weight of the granule, (a) greater than 35% of a fragrance material; (b) from 1% to 30% of an inorganic density enhancing additive; and (c) from 1% to 50% of a carbohydrate carrier; wherein the granule has a skeletal density of from 1.00 g/mL to 1.40 g/mL and a bulk density of from 0.20 g/mL to 1.40 g/mL.

### FIELD OF THE DISCLOSURE

The present disclosure relates to fragrance-containing granules with improved performance and/or fragrance benefits and their method of production, as well as their use in consumer products, particularly in animal litter. More particularly, the fragrance-containing granules are configured to provide malodor control benefits caused by the absorbed waste (e.g., urine and/or feces) in animal litter.

### BACKGROUND OF THE DISCLOSURE

Most commercial animal litters, particularly companion animals (e.g., cat litters), include a technology that provides a release of fragrance or odor masking scent to reduce and/or mask the malodors associated with the absorbed waste (e.g., urine and/or feces). One such current technology is spray dried powder containing neat fragrances, which is then dry-blended with the litter particles. Typically, spray dried fragrance-containing powder is formed by emulsification of fragrance oil in water and spray dried to evaporate the water to obtain the spray dried fragrance-containing powder. The resultant spray dried fragrance-containing powder has an approximate average particle size of between about 10 μm and about 100 μm, while the litter particles have an approximate average particle size of between about 0.4 mm and about 2.3 mm. There are several drawbacks to incorporating the current spray dried fragrance-containing powder with the litter particles.

Firstly, there is a lack of uniform distribution of the spray dried fragrance-containing powder and the littler particles due to the large difference between their particle sizes. This is a problem because the non-uniform distribution of the fragrance ingredient means that the malodor reduction varies in strength between each poured sample leading to inconsistent user experience. Secondly, the smaller spray dried fragrance-containing powder creates high dust levels during production which can lead to increased risk of dust explosions of the particles suspended in the air and presents challenges for litter handling equipment. Another challenge with the smaller spray dried fragrance-containing powder is that they tend to segregate from the larger litter particles to create high dust levels during use (e.g., pouring or scooping). As a result, this creates an undesirable mess in the consumer's home. Thirdly, it has been observed that spray dried fragrance-containing powder lack sufficient density and easily stick to the animal's fur and paws or leave the animal litter box due to the animal's activity in or near the box (i.e., “tracking”). Lastly, the existing approach does not teach how to improve the fragrance profile, more specifically how to selectively increase and/or extend the intensity of the more desirable characters attributable from the high volatile fragrance materials (i.e., top notes) that work best to minimize waste malodor.

For instance, WO 03/043728A1 (Firmenich) discloses perfuming granules having fireproofing agents dispersed in or absorbed within a polymeric carrier material, however, the fireproofing agents disclosed in this document have to be used in large amounts compared to the amount of granules, therefore this solution is not cost-effective and does not fully address the other problems identified herein. WO 2019/170528A1 (Firmenich) discloses the use of talc as a fireproofing agent to prevent explosion risk of granules during their preparation and/or handling. According to para. [0119, 0129] of WO '528A1, talc powder is dry blended with the granules to cover their surface in a dust cloud to reduce the explosion risk. There are several drawbacks of this approach. Firstly, the talc being merely coated on the granules could readily come off over time, leaving undesirable residues in the animal litter. Secondly, merely coating the granules with a layer of talc powder does not help to regulate granules size to match those of the animal litter. Thirdly, talc powder is potentially hazardous to human health (e.g., asbestos in talc powder) and obtained in a non-environmentally manner (i.e., mining in natural protected habitats).

As such, these existing solutions still have limitations and do not adequately teach how to overcome the above-mentioned problems. Accordingly, there remains a need in the art for the development of new fragrance-containing granules that can address one or more of the problems noted above, and which are suitable for use in a variety of consumer products, particularly in animal litter. There is also a need for these fragrance-containing granules to be sustainable and/or are more renewably sourced. It is also desirable that the fragrance-containing granules are useful to improve intensity of the fragrance profile, particularly fragrances derived from high volatile fragrance materials (i.e., top notes).

### BRIEF SUMMARY OF THE DISCLOSURE

The granule of the present disclosure is based, inter alia, on the discovery of new fragrance-containing granules that have specific combinations of parameters that, when blended into consumer products, particularly in animal litter, allow them to deliver certain benefits including for non-limiting examples, malodor control benefits with minimal (i.e., low) or virtually no dusting and/or tracking and/or improved fragrance profile, especially character intensity derived from high volatile fragrance materials (i.e., top notes).

Thus, in a first aspect, the present disclosure provides a fragrance-containing granule comprising, by weight based on the weight of the granule, (a) greater than 35% of a fragrance material; (b) from 1% to 30% of an inorganic density enhancing additive; and (c) from 1% to 50% of a carbohydrate carrier; wherein the granule has a skeletal density of from 1.00 g/mL to 1.40 g/mL and a bulk density of from 0.20 g/mL to 1.40 g/mL. Preferably the granule has a bulk density of from about 0.30 g/mL to about 0.60 g/mL.

In another aspect, the present disclosure provides a consumer product comprising the fragrance-containing granule of the present disclosure, wherein the consumer product is selected from the group consisting of powder laundry detergent, powder automatic dishwasher detergent, animal litter, bath salt, room deodorizer, room de-humidifier, powder fabric bleach, powdered soap and powdered cleaner. Preferably, the consumer product is animal litter, more preferably cat litter, and further comprises a particulate material. More preferably, the animal litter has one or more characteristics selected from the group consisting of enhanced malodor control, lower tracking and lower dusting as compared to an animal litter comprising a spray dried fragrance-containing powder.

In yet another aspect, the present disclosure provides a method of producing animal litter, comprising: (i) providing a particulate material comprising an absorbent material and optionally at least one performance-enhancing active selected from the group consisting of antimicrobials, odor absorbers, odor inhibitors, binders that promote clumping, health indicating materials, non-stick release agents, light-weighting minerals, miller materials, and combinations thereof; and (ii) mixing the granule of the present disclosure and the particulate material; wherein the particulate material has an average particle size ranging from 400 μm to 4 mm.

In yet another aspect, the present disclosure provides a method of imparting a fragrance to animal litter, comprising admixing: (i) from about 0.02 wt % to about 5 wt %, relative to the total weight of the animal litter, of the granule of the present disclosure, and (ii) from about 99.98 wt % to about 95 wt %, relative to the total weight of the animal litter, of a particulate material. Preferably, the animal litter exhibits one or more characteristics selected from the group consisting of enhanced malodor control, lower tracking, and lower dusting as compared to an animal litter comprising a spray dried fragranced powder.

It is an advantage of the present disclosure to provide new fragrance-containing granules that can provide one or more performance and/or sensorial benefits. In particular, it is an advantage that the granules of the present disclosure have larger particle size (2-3 mm) than traditional spray-dried particles (about 50 microns). The larger sized fragrance-containing granules according to the present disclosure have multiple benefits. Firstly, the larger particle size of the fragrance-containing granules means that they are more similar in size with, for example, the animal litter particles (0.2-2.3 mm) with which they are admixed. This uniformity of size allows for a more even distribution of the fragrance ingredients thereby providing a more consistent user experience with each poured sample of the animal litter. Secondly, the larger sized fragrance-containing granules are easier to handle, produce less dust (i.e., small particles below 250 μm in diameter) during production and/or represent a reduced explosive risk. Thirdly, the larger size also provides less surface area to volume ratio for the fragrance materials to diffuse out during storage, causing an improvement in the fragrance retention over time, particularly fragrance derived from top notes (see below).

It is yet a further advantage of the present disclosure to provide fragrance-containing granules that deliver prolonged perceived intensity of the fragrance profile, particularly characters attributable to high volatile fragrance materials having a vapor pressure greater than 0.1 Torr (0.0133 kPa) (i.e., “top notes”).

All parts, percentages and proportions referred to herein and in the claims are by weight unless otherwise indicated.

The values and dimensions disclosed herein are not to be understood as being strictly limited to the exact numerical values recited. Instead, unless otherwise specified, each such value is intended to mean both the recited value and a functionally equivalent range surrounding that value. For example, a value disclosed as “50%” is intended to mean “about 50%”.

### BRIEF DESCRIPTION OF THE DRAWING

Embodiments are illustrated in the accompanying figures to improve understanding of concepts as presented herein.

FIG. 1 shows the fragrance intensity of top notes from the fragrance-containing granule of the present disclosure and the comparative spray dried fragrance-containing powders.

FIG. 2 shows the process scheme for manufacturing an embodiment of the fragrance-containing granule of the present disclosure.

### DETAILED DESCRIPTION

The foregoing general description and the following detailed description are exemplary and explanatory only and are not restrictive of the invention, as defined in the appended claims. Other features and benefits of any one or more of the embodiments will be apparent from the following detailed description, and from the claims.

As used herein, the terms “comprises”, “comprising”, “includes”, “including”, “has”, “having”, “contains”, “containing” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. For example, when a range of “1 to 10” is recited, the recited range should be construed as including ranges “1 to 8”, “3 to 10”, “2 to 7”, “1.5 to 6”, “3.4 to 7.8”, “1 to 2 and 7-10”, “2 to 4 and 6 to 9”, “1 to 3.6 and 7.2 to 8.9”, “1-5 and 10”, “2 and 8 to 10”, “1.5-4 and 8”, and the like.

The present disclosure illustratively described herein suitably may be practiced in the absence of any element or elements, limitation or limitations that are not specifically disclosed herein. While compositions and methods are described herein in terms of “comprising” various components or steps, the compositions and methods also can “consist essentially of” or “consist of” the various components or steps, unless stated otherwise.

Before addressing details of embodiments described below, some terms are defined or clarified.

The term “wt %”, as used herein, means percentage by weight.

As used herein, the term “animal litter” refers to a solid composition comprising particulate material. Preferably, the particulate material comprises an absorbent material. In some embodiments, the particulate material has an average particle size ranging from 400 μm to 4 mm. The average particle size in this disclosure is measured by means of sieve screen analysis according to the standard ASTM methodology (ASTM D6913-04e1).

The term “absorbent material”, as used herein as a (component of) particulate material for animal litter, means a liquid-absorbing material. The absorbent material can be made from materials selected from the group consisting of clays (e.g., bentonite), woods (e.g., pine, cedar), wood byproducts (e.g., sawdust), grains and ground grains (e.g., corn), agricultural products and byproducts (e.g., corncob, dried distillers grains), silica gel, wheat, grass seed, crushed walnut shells, paper pellets, celluloses, and mixtures thereof. Other examples of suitable absorbent materials are disclosed in WO2013/180896A1, the disclosure of which is incorporated herein by reference in its entirety for all purposes.

As used herein, the term “average granular weight” means the average granular weight calculated by taking the total weight of 3000 granules (in mg), which is then divided by 3000 to obtain an approximate weight of each granule in mg.

As used herein, the term “Average Mean Diameter” means the average mean diameter determined by measuring the diameter distribution of the granules using an image analysis software (e.g., ImageJ Image Analysis Software, Ver. 1.530 (January 2022) available from NIH; MIPAR Image Analysis Software, Ver. 3.4, available from MIPAR Image Analysis (Columbus, Ohio); or Pax-It Image Management System, Ver.1.3, available from Pax-It!™). A digital photo is taken of the granules using a size reference in the photo. Then the image analysis software measures the diameter of the granules (e.g., several hundreds). It then calculates the Average Mean Diameter along with the standard deviation.

The terms “obtainable” and “obtained” can be used interchangeably in this disclosure and do not mean to indicate that, e.g., a product must be obtained by, e.g., the sequence of steps following the term “obtained” though such a limited understanding is always included by the terms as a preferred aspect of the present disclosure.

As used herein, the term “biobased” refers to atoms or molecules obtained from biomass, e.g., obtained from materials containing organic carbon of renewable origin. Sources of such carbon can be derived from agricultural products, plants, animals, fungi, microorganisms, marine, or forestry materials.

The term “biodegradable” as used herein with respect to a material, such as microcapsule shell and/or fragrance, means that the material has no real or perceived health and/or environmental issues, and can undergo and/or does undergo physical, chemical, thermal, microbial and/or biological degradation. Ideally, a microcapsule shell and/or fragrance is deemed “biodegradable” when the microcapsule shell and/or fragrance passes one or more of the following tests including: a respirometry biodegradation method in aquatic media, available from Organization for Economic Cooperation and Development (OECD), International Organization for Standardization (ISO) and the American Society for Testing and Material (ASTM) tests including, but not limited to OECD 301F or 310 (Ready biodegradation), OECD 302 (inherent biodegradation), ISO 17556 (solid stimulation studies), ISO 14851 (fresh water stimulation studies), ISO 18830 (marine sediment stimulation studies), OECD 307 (soil stimulation studies), OECD 308 (sediment stimulation studies), and OECD 309 (water stimulation studies). Preferably, the microcapsule shell and/or fragrance is readily biodegradable as determined using a respirometry biodegradation method in aquatic media, the OECD 301F or OECD 310 test. More preferably, the microcapsule shell and/or fragrance is biodegradable if the shell and/or fragrance has a biodegradation rate of at least 20%, 30%, 40%, 50%, 60%, 65%, 70%, 75%, 80%, 85%, 90%, 95% or 98%, based on the weight of the shell and/or fragrance, within 60 days according to the OECD301F or OECD310 tests, or most preferably a biodegradability of at least 60% within 60 days according to OECD301F test.

As used herein, the term “bulk density” means the mass of the fragrance-containing granules divided by the total volume they occupy. The total volume includes granule volume, inter-granule void volume and intra-granule void volume. Bulk density differs from skeletal density in that it includes both intra and inter granule voids. Bulk density is determined by the method as described in the Bulk Density Test (Test Method 2).

As used herein, the term “consumer” means both the user of the composition and the observer nearby or around the user.

The terms “fragrance”, “fragrance components”, “fragrance materials” and “fragrance ingredients” are used interchangeably, and refer to a composition of fragrance compounds for the purpose of delivering a specific and/or pleasant fragrance profile to drive consumer delight or acceptance of the consumer product and/or fragrance composition. “Fragrance material(s)” mean a perfume raw material (“PRM”), or a mixture of perfume raw materials (“PRMs”), that are used to impart an overall pleasant odor or fragrance profile to a composition. “Fragrance materials” can encompass any suitable perfume raw materials for fragrance uses, including materials such as, for example, alcohols, aldehydes, ketones, esters, ethers, acetates, nitriles, terpene hydrocarbons, nitrogenous or sulfurous heterocyclic compounds and essential oils. However, naturally occurring plant and animal oils and exudates comprising complex mixtures of various chemical components are also known for use as “fragrance materials”. The individual perfume raw materials which comprise a known natural oil can be found by reference to Journals commonly used by those skilled in the art such as “Perfume and Flavourist” or “Journal of Essential Oil Research”, or listed in reference texts such as the book by S. Arctander, Perfume and Flavor Chemicals, 1969, Montclair, New Jersey, USA and more recently re-published by Allured Publishing Corporation Illinois (1994). Additionally, some perfume raw materials are supplied by the fragrance houses (Firmenich, International Flavors & Fragrances, Givaudan, Symrise) as mixtures in the form of proprietary specialty accords.

As used herein, the term “fragrance profile” means the description of how the fragrance is perceived by the human nose at any moment in time. The fragrance profile may change over time. It is a result of the combination of the base, heart and top notes, if present, of a fragrance. Base notes are characterized by providing animalic, woody, sweet, amber or musky characters, and not being very volatile. Heart notes are associated with desirable characters such as floral characters (e.g., jasmin, rose), fruity, marine, aromatic or spicy characters. The “top or head notes” provide citrusy, green, light, or fresh characters and tend to evaporate quickly due to their high volatility. A fragrance profile is composed of 2 characteristics: “intensity” and “character”. The “intensity” relates to the perceived strength whilst “character” refers to the odor impression or quality of the perfume, i.e., fresh, clean, etc.

As used herein, the term “granule” refers to a particle which contains a core (typically a small core particle) and an active agent (typically a fragrance). The term “granule” may also refer to fibers, flakes, spheres, powders, platelets and other shapes and forms.

As used herein, the term “maximum explosion pressure” (MEP) is referred to as the difference between the pressure at ignition time (ambient pressure) and the pressure at culmination point of explosion. Both the MEP and explosion severity values (Kst value) are measured in a 20 L apparatus or in a 1 m³ vessel at different concentrations according to test conditions specified in ISO 6184/1 (1995) and ASTM Standard E1226 (1991). All measurements are performed by Dekra US, Atlanta, Georgia.

As used herein, the term “minimum ignition energy” (MIE) refers to the ignition sensitivity of a dust/air mixture in the presence of electric sparks and is typically expressed in units of mJ. MIE is determined by the method described in Test Method 4 (MIE Test) of this disclosure.

As used herein, the terms “particle size dispersity index” (PSDI) and “polydispersity index” are used interchangeably and mean the distribution of size populations within a mixture of the fragrance-containing granule and the particulate material. In this disclosure, the particle size dispersity index (PSDI) is calculated as the standard deviation divided by the mean diameter of the fragrance-containing granule and the particulate material.

As used herein, the term “substantially free” in reference to a material means that the indicated material is present in an amount of from 0 wt % to about 1 wt %, preferably from 0 wt % to about 0.5 wt %, or more preferably from 0 wt % to 0.2 wt %. The term “essentially free” means that the indicated material is present in an amount of from 0 wt % to about 0.1 wt %, preferably from 0 wt % to about 0.01 wt %, or more preferably it is not present at analytically detectable levels.

As used herein, the term “skeletal density” is the ratio of the mass of solid material contained in a granule to the sum of the volumes of the solid material and closed (or blind) pores within the granule. Skeletal density in this disclosure is determined by the method as described in the Skeletal Density Test (Test Method 1).

As used herein, the term “vapor pressure” means the partial pressure in air at a defined temperature (e.g., 25° C.) and standard atmospheric pressure (760 mmHg) for a given chemical species. It defines a chemical species' desire to be in the gas phase rather than the liquid or solid state. The higher the vapor pressure the greater the proportion of the material that will, at equilibrium, be found in a closed headspace. It is also related to the rate of evaporation of a fragrance material which is defined in an open environment where material is leaving the system. Vapor pressure is determined in accordance with Test Method 1 (Determining Vapor Pressure) of WO2016/200761A1, the content of which is incorporated herein by reference.

As used herein, the term “high volatile fragrance material” refers to fragrance materials that have a vapor pressure greater than 0.1 Torr (0.0133 kPa) at 25° C. (i.e., top notes).

The term “water activity (a_{w})”, as used herein with respect to a substance (e.g., granule), means the partial vapor pressure of water in the substance at a given temperature divided by the partial vapor pressure of pure water at the same temperature.

As used herein, the terms “g”, “mg”, and “μg” refer to “gram”, “milligram”, and “microgram”, respectively. The terms “L” and “mL” refer to “liter” and “milliliter”, respectively. The terms “mm” and “μm” refer to “millimeter” and “micrometer”, respectively.

It is understood that the test methods that are disclosed in the Test Methods Section of the present application must be used to determine the respective values of the parameters of Applicants' inventions as described and claimed herein.

### Fragrance-Containing Granules

Inventors have surprisingly discovered new fragrance-containing granules that have specific combinations of parameters that allow them to deliver certain benefits, including for non-limiting examples, similar particle size with the particulate material in an animal litter for more uniform blending, enhanced malodor control benefits, minimal (i.e., low) or virtually no dusting and/or tracking, and/or improved fragrance profile, especially character intensity derived from high volatile fragrance materials (i.e., top notes).

Specifically, in one aspect, the present disclosure provides a fragrance-containing granule comprising, by weight based on the weight of the granule, (a) greater than about 35% of a fragrance material; (b) from about 1% to about 30% of an inorganic density enhancing additive; and (c) from about 1% to about 50% of a carbohydrate carrier; wherein the granule has a skeletal density of from about 1.00 g/mL to about 1.40 g/mL and a bulk density of from about 0.20 g/mL to about 1.40 g/mL. In some embodiments, the granule comprises, by weight based on the weight of the granule, at least 40%, or at least 45%, or at least 50%, of a fragrance material. In some embodiments, the granule comprises, by weight based on the weight of the granule, from about 5% to about 30%, or from about 15% to about 30%, or from about 17% to about 28% of an inorganic density enhancing additive. In some embodiments, the granule has a bulk density of from about 0.30 g/mL to about 0.60 g/mL. In some embodiments, the granule has a bulk density of from about 0.30 g/mL to about 0.40 g/mL.

Typically, animal litter has a bulk density of from about 1.20 g/mL to about 1.30 g/mL. Inventors have discovered that in order to minimize or eliminate segregation of the granules when admixed with the animal litter, the bulk density of the granule has to be greater than about 0.20 g/mL, preferably greater than about 0.25 g/mL, more preferably greater than about 0.30 g/mL, or even more preferably greater than about 0.35 g/mL. In some embodiments, the bulk density of the granule is no more than 1.20 g/mL, or no more than 1.10 g/mL, or no more than 1.0 g/mL, or no more than 0.9 g/mL, or no more than 0.8 g/mL, or no more than 0.7 g/mL, or no more than 0.6 g/mL, or no more than 0.5 g/mL.

In some embodiments, the fragrance-containing granules may be formed into spheres, hemispheres and the like. The granule can have any shape selected from the group consisting of spherical, hemispherical, compressed hemispherical, disc, circular, lentil-shaped, oblong, and combinations thereof, preferably hemispherical or compressed hemispherical. As used herein, “lentil-shaped” refers to the shape of a lentil bean, and “compressed hemispherical” refers to a shape corresponding to a hemisphere that is at least partially or substantially flattened such that the curvature surface is less, on average, than the curvature of a hemisphere having the same radius. A compressed hemispherical particle can have an aspect ratio (i.e., the ratio of its base diameter over its height that is orthogonal to the base) of from about 2.0 to about 5, alternatively form about 2.1 to about 4.5, alternatively from about 2.2 to about 4. “Oblong-shaped” granule refers to a particle having a maximum dimension and a secondary dimension orthogonal to the maximum dimension, wherein the ratio of maximum dimension to the secondary dimension is greater than about 1.2, preferably greater than about 1.5, more preferably greater than about 2. Additionally, the granule of the present disclosure may have been ruptured and deformed during the drying step of the production process. As a result, the granules may have an irregular shaped hemispheres or compressed hemispheres.

In some embodiments, fragrance-containing granules of the present disclosure can have different shapes, sizes, and/or skeletal density. In some embodiments, the fragrance-containing granules are added as a component in consumer products. For example, the granules may be added to an animal litter. Given that the fragrance-containing granules are differently shaped and/or sized from the particulate material in the animal litter, it is likely that they will segregate from the particulate material during transport and storage. Such segregation may lead to significant variations in the amount of the fragrance-containing granules in the particulate animal litter composition from scope to scope. It has been discovered that such hemispherical or compressed hemispherical shape helps to significantly reduce segregation of the fragrance-containing granules in the animal litter composition, e.g., by at least about 20%, at least about 30%, at least about 40%, at least about 50%, at least about 60%, at least about 70%, or at least about 80%, in comparison with fragrance-containing granules having other shapes.

### Fragrances

In some embodiments, an animal litter comprises the fragrance-containing granule of this disclosure. In some embodiments, the fragrance-containing granule is used to produce animal litter. When the fragrance-containing granule is used in an application for animal litter, the granule may comprise, by weight based on the weight of the granule, no more than 35% of a fragrance material, while still be able to deliver the desired malodor control benefits. That is because animal litter are scooped often so that the waste is regularly removed. Therefore, the animal litter does not require a high payload of fragrance materials to be able to adequately control the malodor. Moreover, high payload of fragrance would not be cost effective, given that animal litter is a relatively inexpensive product. Accordingly, when the fragrance-containing granule is used for animal litter (e.g., as a component in an animal litter, or used in a method of producing animal litter), the granule may comprise, by weight based on the weight of the granule, no more than 50%, or no more than 45%, or no more than 40%, or no more than 35%, or no more than 30%, or no more than 25%, or no more than 20%, of a fragrance material. In some embodiments, the granule comprises, by weight based on the weight of the granule, at least 0.1%, or at least 1%, or at least 5%, or at least 10%, or at least 15%, of a fragrance material.

In some embodiments, the granule of the present disclosure has a prolonged and/or stronger perceived intensity of the fragrance profile, particularly characters attributable to high volatile fragrance materials having a vapor pressure greater than 0.1 Torr (0.0133 kPa) at 25° C. (i.e., top notes), compared with a comparative spray dried fragrance-containing powder according to the Olfactive Test (Test Method 3) as described in this disclosure. The term “comparative spray dried fragrance-containing powder”, as used herein comparing with a fragrance-containing granule of this disclosure, means a spray dried powder prepared with the same formula (i.e., same ingredients and same amounts except water) as used to prepare the fragrance-containing granule. In some embodiments, the high volatile fragrance material is selected from the group consisting of butyl acet, eth-2-meth buty, iso amyl acet, manzanate, prenyl acet, orange oil, acet C-6, iso amyl buty, allyl caproate, and combinations thereof.

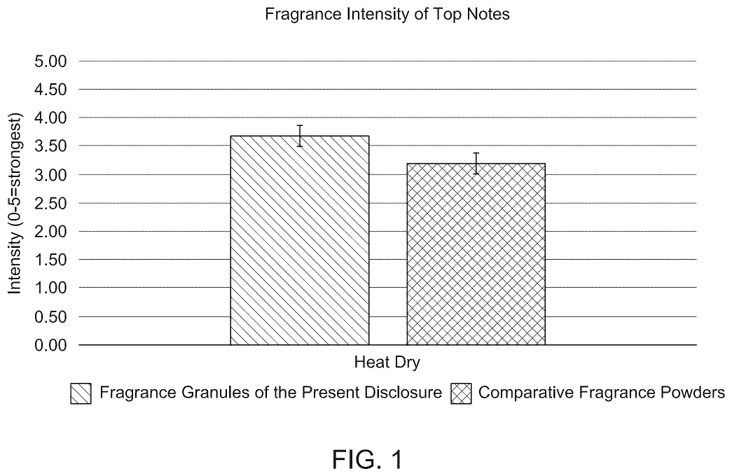

Preferably the perceived intensity of the fragrance profile of the fragrance-containing granule at 1 min (minute), 2 mins (minutes), 3 mins, 4 mins, 5 mins, 6 mins, 7 mins, 8 mins, 9 mins, 10 mins, 15 mins, 20 mins, 25 mins, 30 mins, 35 mins, 40 mins, 45 mins, 50 mins, 55 mins, or 60 mins or longer after adding water to the granule is stronger than the comparative spray dried fragrance-containing powder as determined by the Olfactive Test (Test Method 3). For example, a sample of comparative spray dried fragrance-containing powder indicates a lower fragrance intensity (~3.2) of top notes, such as fruit and citrus, at 5 minutes after adding water to the powder (see FIG. 1), according to the Olfactive Test (Test Method 3). In comparison, a sample of the fragrance-containing granule of the present disclosure indicates a higher fragrance intensity (~3.7) of the top notes at 5 minutes after adding water to the granule (see FIG. 1). This means that the fragrance-containing granule of the present disclosure can retain more of the top notes than comparative spray dried fragrance-containing powder.

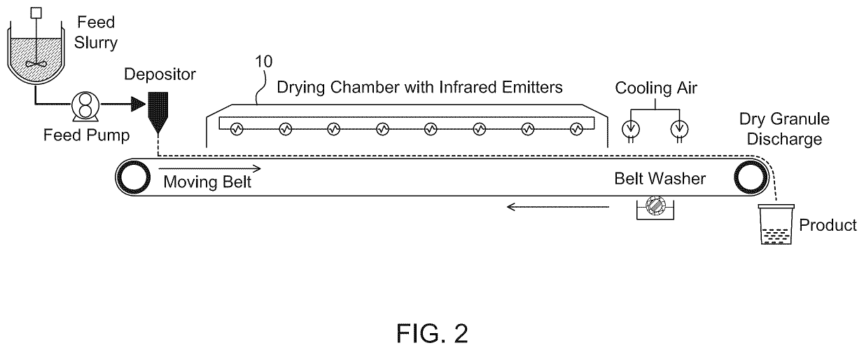

It is believed that better retention of the top notes is due, at least in part, to the lower processing temperature used to make the fragrance-containing granules. As used herein, the term “processing temperature” refers to the air temperature in the drying chamber that is used as part of the manufacturing process. With reference to FIG. 2, measurement of the “processing temperature” refers to measurement of air temperature in the drying component (10) of the drying chamber. With the process used to make the fragrance-containing granules of the present disclosure, the estimated peak processing temperature as measured at the drying component (10) is 115° C.±10° C. It should be noted that temperature measurements in infrared dryers are tricky, since infrared energy absorbance varies by material type. These temperature readings were done in a manner so that the probes were not directly “in line of sight” to the infrared emitters. Bare thermocouple wires (K-type) were placed approximately 1 cm above the conveyor belt. In this manner, the temperature readings were the best practical measurement of air temperatures near the fragrance-containing granules surface. Also, the above-noted 115° C.±10° C. reading was obtained without fragrance-containing granules on the conveyor belt, so there was no evaporative cooling effect. During active drying (i.e., water evaporation) the air temperature above the belt was significantly lower, in the range of 80° C.±5° C.

In contrast, the processing temperatures used in spray drying process are significantly higher. For example, typical spray drying inlet air temperature is about 190-210° C. Therefore, it is believed that the lower processing temperature of the process to make the fragrance-containing granules of the present disclosure allows for better retention of the top notes. Without wishing to be bound by theory, it is also believed that a larger particle size with lower surface area, lower temperature and lower level of water in the emulsion means that less energy is required to remove the water from the emulsion to form the dry granule. This in turn means less fragrance oil, especially the more volatile top notes, are unintentionally removed during the heating/water removal process of making the granules.

The high volatile fragrance materials (i.e., top notes) can be selected from the group consisting of a banana-type note, a fruity-type note, a green-type note, and combinations thereof. In some embodiments, the fragrance material comprises from about 1 wt % to about 50 wt %, or from about 5 wt % to about 40 wt %, or from about 10 wt % to about 30 wt % high volatile fragrance materials, based on the total weight of the fragrance material. In some embodiments, the fragrance material comprises at least 1 wt %, or at least 2 wt %, or at least 5 wt %, or at least 10 wt %, or at least 15 wt %, or at least 20 wt % high volatile fragrance materials, based on the total weight of the fragrance material. In some embodiments, the fragrance material comprises no more than 60 wt %, or no more than 55 wt %, or no more than 50 wt %, or no more than 45 wt %, or no more than 40 wt %, or no more than 35 wt %, or no more than 30 wt %, or no more than 25 wt % high volatile fragrance materials, based on the total weight of the fragrance material. Preferred non-limiting examples of high volatile fragrance materials are provided in Table 1a and include combinations thereof.

TABLE 1a
High Volatile Fragrance Materials - Vapor Pressure

| | | | | Vapor | |
|---|---|---|---|---|---|
| | | | | Pressure | |
| | CAS | | Common | (Torr at | Odor |
| No. | Number | IUPAC Name | Name | 25 °C) | Profile |
| 1 | 123- | butyl acetate | Butyl acet | 7.79 Torr | fruit-type |
| | 86-4 | | | (1.04 kPa) | note |
| 2 | 7452- | ethyl 2- | Eth-2-meth | 6.56 Torr | fruit-type |
| | 79-1 | methylbutanoate | buty | (0.87 kPa) | note |
| 3 | 123- | 3-methylbutyl | Iso amyl | 4.38 Torr | fruit-type |
| | 92-2 | acetate | acet | (0.58 kPa) | note |
| 4 | 39255- | ethyl 2-methyl | Manzanate | 2.64 Torr | green-type |
| | 32-8 | pentanoate | | (0.35 kPa) | note |
| 5 | 1191- | 3-methylbut-2- | Prenyl acet | 2.28 Torr | fruit-type |
| | 16-8 | enyl acetate | | (0.31 kPa) | note |
| 6 | 97766- | 4R)-1-methyl-4- | Orange oil | 1.06 Torr | citrus-type |
| | 30-8 | (prop-1-en-2- | cp toco | (0.14 kPa) | note |
| | | yl)cyclohex-1-ene | | | |
| 7 | 142- | hexyl acetate | Acet c-6 | 0.91 Torr | fruit-type |
| | 92-7 | | | (0.12 kPa) | note |
| 8 | 106- | 3-methylbutyl | Iso amyl | 0.61 Torr | fruit-type |
| | 27-4 | butyrate | buty | (0.08 kPa) | note |
| 9 | 123- | prop-2-enyl | Allyl | 0.68 Torr | fruit-type |
| | 68-2 | hexanoate | caproate | (0.09 kPa) | note |

In some embodiments, the high volatile fragrance materials have a log P value (partition coefficient) of >1.6, preferably from about 1.7 to about 5.0. Preferred non-limiting examples of such high volatile fragrance materials are provided in Table 1b and include combinations thereof.

TABLE 1b
High Volatile Fragrance Materials - logP

| | | | Common | |
|---|---|---|---|---|
| No. | CAS Number | IUPAC Name | Name | logP |
| 1 | 123-86-4 | butyl acetate | Butyl acet | 1.84 |
| 2 | 7452-79-1 | ethyl 2- | Eth-2-meth | 2.26 |
| | | methylbutanoate | buty | |
| 3 | 123-92-2 | 3-methylbutyl | Iso amyl acet | 2.25 |
| | | acetate | | |
| 4 | 39255-32-8 | ethyl 2-methyl | Manzanate | 2.76 |
| | | pentanoate | | |
| 5 | 1191-16-8 | 3-methylbut-2- | Prenyl acet | 2.18 |
| | | enyl acetate | | |
| 6 | 97766-30-8 | (4R)-1-methyl-4- | Orange oil cp | 4.70 |
| | | (prop-1-en-2- | toco | |
| | | yl)cyclohex-1-ene | | |
| 7 | 142-92-7 | hexyl acetate | Acet c-6 | 2.83 |
| 8 | 106-27-4 | 3-methylbutyl | Iso amyl buty | 3.25 |
| | | butyrate | | |
| 9 | 123-68-2 | prop-2-enyl | Allyl caproate | 3.13 |
| | | hexanoate | | |

In some embodiments, the fragrance material comprises a neat fragrance. As used herein, the term “neat fragrance” means a fragrance component that is free from extraneous matter and is unencapsulated and/or unbound from other compounds that would cause a delay in the release of the fragrance component. In some embodiments, the fragrance material is a neat fragrance, and the granule has a weight ratio of component (a) (neat fragrance) to the sum of components (b) (inorganic density enhancing additive) and (c) (carbohydrate carrier) of from 10:90 to 60:40.

In some embodiments, the fragrance material comprises an encapsulated fragrance. As used herein, the term “encapsulated fragrance” means a fragrance component which is encapsulated in a microcapsule (in order to stabilize the odor impression over a prolonged period). Microcapsules are used to deliver fragrances to a target area in a time-delayed or controlled manner. For example, the encapsulated fragrance can be used to deliver targeted fragrances when the granules are activated by physical force from the animal. In some embodiments, the microcapsule has an average particle size of from 1 and 100 microns, preferably from 1 to 50 microns or more preferably from 1 to 20 microns. The microcapsules may be prepared from natural materials like fungal chitosan (WO2016/185171A1), silk fibroin particles (US2015/0164117A1), and biomolecules used as emulsifiers in microcapsule preparation (WO2016/193435A1, WO2017/102812A1, US2018/0078468A1, WO2018/019894A1, WO2018/019896A1 and WO2017/102812A1). Microcapsules comprising multilayered coacervate between gelatin and gum Arabic may be used in the present disclosure (U.S. Pat. No. 4,946,624, WO2012/001604A1, US2015/0250689A1 and WO2018/002214A1). Protein microcapsules are also useful within the scope of the present disclosure (US2017/0189283A1). In some embodiments, environmentally friendly microcapsules where the shell has a biodegradability of at least 60% within 60 days according to OECD 301F are also within the scope of the present disclosure (WO2021/122633A1).

In some embodiments, the encapsulated fragrance is encapsulated by a biodegradable microcapsule shell. Preferably, the biodegradable microcapsule shell has a biodegradation rate of at least 20%, at least 30%, at least 40%, at least 50%, at least 60%, at least 65%, at least 70%, at least 75%, at least 80%, at least 85%, at least 90%, least 95%, or at least 98%, based on the weight of the microcapsule shell, within 60 days according to OECD301F or OECD310, preferably at least 60%, based on the weight of the microcapsule shell, within 60 days according to OECD301F. As used herein, the terms “wall” and “shell” are used interchangeably to denote the structure formed by the microencapsulating polymer surrounding the active material (e.g., fragrance) core being microencapsulated.

In some embodiments, the fragrance material comprises a neat fragrance and an encapsulated fragrance, and the total amount of the neat fragrance and the encapsulated fragrance is at least 0.1%, at least 1%, at least 5%, at least 10%, at least 15%, at least 20%, at least 25%, at least 30%, at least 35%, or at least 40%, by weight based on the total weight of the granule. In some embodiments, the fragrance material comprises a neat fragrance and an encapsulated fragrance, and the total amount of the neat fragrance and the encapsulated fragrance is no more than 20%, no more than 25%, no more than 30%, no more than 35%, no more than 40%, no more than 45%, no more than 50%, no more than 55%, no more than 60%, no more than 65%, or no more than 70%, by weight based on the total weight of the granule. In some embodiments, the weight ratio of the neat fragrance to the encapsulated fragrance is from 10:1 to 1:1. In some embodiments, the weight ratio of the neat fragrance to the encapsulated fragrance is from 8:1 to 2:1, or from 7:1 to 2:1, or from 6:1 to 3:1, or from 5:1 to 3:1. In some embodiments, the weight ratio of the neat fragrance to the encapsulated fragrance is at least 0.5:1, or at least 0.8:1, or at least 1:1, or at least 2:1, or at least 3:1. In some embodiments, the weight ratio of the neat fragrance to the encapsulated fragrance is no more than 15:1, or no more than 12:1, or no more than 11:1, or no more than 10:1, or no more than 9:1, or no more than 8:1, or no more than 7:1, or no more than 6:1, or no more than 5:1.

In some embodiments, the fragrance material is essentially free of an encapsulated fragrance. In some embodiments, the fragrance material comprises no more than 5%, no more than 3%, no more than 1%, no more than 0.5%, or no more than 0.2% of an encapsulated fragrance, by weight based on the total weight of the fragrance material. In some embodiments, the fragrance material consists essentially of or consists of a neat fragrance.

### Inorganic Density Enhancing Additive

An inorganic density enhancing additive is added to a granule in order to increase the bulk density and the skeletal density of the granule. Preferably, the inorganic density enhancing additive is selected from materials that are biodegradable and/or environmentally friendly. In some embodiments, the inorganic density enhancing additive is selected from the group consisting of titanium dioxide, talc, silicon dioxide, calcium carbonate, calcium silicate, sodium silicate, zinc oxide, magnesium oxide, magnesium silicate, magnesium aluminum silicate, clay (e.g., bentonite clay), trisodium phosphate, and combinations thereof. In some embodiments, the inorganic density enhancing additive comprises or is titanium dioxide and/or calcium silicate. In some embodiments, the inorganic density enhancing additive comprises or is silicon dioxide.

The granule of the present disclosure comprises from about 1 wt % to about 30 wt % of the inorganic density enhancing additive relative to the total weight of the granule. In some embodiments, the granule comprises from about 5 wt % to about 30 wt %, or from about 5 wt % to about 25 wt %, or from about 15 wt % to about 30 wt %, or from about 15 wt % to about 25 wt %, or from about 17 wt % to about 28 wt % of an inorganic density enhancing additive, based on the weight of the granule. In some embodiments, the granule comprises at least 1 wt %, or at least 2 wt %, or at least 3 wt %, or at least 4 wt %, or at least 5 wt %, or at least 6 wt %, or at least 7 wt %, or at least 8 wt %, or at least 9 wt %, or at least 10 wt %, or at least 12 wt %, or at least 15 wt %, or at least 17 wt %, or at least 20 wt % of the inorganic density enhancing additive, based on the total weight of the granule. In some embodiments, the granule comprises no more than 35 wt %, or no more than 32 wt %, or no more than 30 wt %, or no more than 28 wt %, or no more than 26 wt %, or no more than 24 wt %, or no more than 22 wt %, or no more than 20 wt % of the inorganic density enhancing additive, based on the total weight of the granule.

### Carbohydrate Carrier

The granule of the present disclosure comprising, by weight based on the weight of the granule, from 1% to 50% of a carbohydrate carrier. In some embodiments, the carbohydrate carrier is water-soluble or water-dispersible. In some embodiments, the carbohydrate carrier has a melting point temperature of at least 70° C., at least 80° C., at least 90° C., or at least 100° C. In some embodiments, the carbohydrate carrier comprises gum Arabic, starch, modified starch, polysaccharide, cellulose, pectin, or a mixture thereof. Preferably the carbohydrate carrier comprises a starch selected from the group consisting of corn starch, potato starch, rice starch, tapioca starch, and mixtures thereof. The starch of the present disclosure can be obtained from seeds, roots or tubers. The starch can be obtained by wet grinding, washing, sieving and drying. Starches are predominantly obtained from corn, wheat and potato, and to a lesser extent, sources such as rice, sweet potato, sago and mung bean. The starch can be unmodified or chemically modified (i.e., modified starch) to allow the starch to function under conditions frequently encountered during processing or storage, such as high heat, high shear, low pH, oxidation, freeze/thaw and/or cooling. Such modifications include, but are not limited to acid treatment, alkaline treatment, bleaching, oxidation, enzyme treatment, acetylation, phosphorylation, or a combination thereof. In some embodiments, the starch comprises or is a modified starch. In some embodiments, the carbohydrate carrier comprises or is a modified starch. In some embodiments, the modified starch is selected from the group consisting of cationic starches, hydroxyethyl starches, carboxymethylated starches, and combinations thereof. In some embodiments, the modified starch comprises or is an octenyl succinic anhydride (OSA) modified starch. In some embodiments, the modified starch comprises or is starch sodium octenyl succinate (E1450). Other types of modifications known to those skilled in the art will also be considered within the scope of the present disclosure. Suitable examples of modified starches include, but are not limited to, CAPSUL® (starch sodium octenyl succinate), CAPSUL® FP, Purity Gum® 2000 (starch sodium octenyl succinate), HI-CAP® IMF, HI-CAP® 100 (starch sodium octenyl succinate), Sta-Mist (Sta-Mist 515) and the like (available from Ingredion, Westchester, IL, USA). In some embodiments, the aqueous (modified) starch solution may include maltose, sucrose, maltodextrin, or a combination thereof. In some embodiments, the aqueous (modified) starch solution may include a cellulose ether.

In some embodiments, the carbohydrate carrier comprises a modified starch and an unmodified starch. As used herein, the term “unmodified starch” means that the starch is not chemically modified. In some embodiments, the carbohydrate carrier comprises gum Arabic. In some embodiments, the carbohydrate carrier is present in the granule in an amount of from about 10 wt % to about 50 wt %, preferably from about 20 wt % to about 40 wt %, based on the total weight of the granule. In some embodiments, the fragrance material is adsorbed into or absorbed onto the carbohydrate carrier.

### Other Parameters

In some embodiments, the fragrance-containing granule of the present disclosure is characterized by the following features:
(i) a water activity (a_{w}) of less than 0.6 at 25° C.; and/or
(ii) an average granular weight of from about 1 mg to about 10 mg, or from about 3 mg to about 7 mg; and/or
(iii) an Average Mean Diameter in the range of from about 1 mm to about 20 mm, or from about 1 mm to about 15 mm, or from about 1 mm to about 10 mm, or from about 1 mm to about 5 mm, or from about 2 mm to about 3 mm.

In some embodiments, the fragrance-containing granule has all the three features as recited above. Fragrance-containing granules with the above-described water activity (a_{w}), average granular weight and Average Mean Diameter can provide a significant improvement over existing scent particles. The fragrance-containing granules with these features are dry and free flowing, high fragrance loading powder/granules that offer protection from air and evaporation. This gives a release of fragrance on demand when needed. For example when the animal urinates the granules partially dissolve and release fragrance. This gives fresher and more long-lasting performance in a convenient and safe manner that avoids unintended ignition of fragrance vapor when handling in a factory and gives less dust and tracking when poured by the consumer.

Another aspect of the present disclosure is the desire to move towards the use of granules, and/or their components (e.g., fragrance ingredients, microcapsules and the like) derived from “Green Chemistry” principles. Green Chemistry is focused on the design of products and processes that minimize environmental impact, particularly by using renewable feedstocks, repurposed and/or upcycled carbon resources that can be replenished to replace the portion depleted by usage and/or consumption, either through natural reproduction, or other recurring processes in a finite amount of time (such as within a human lifetime). In other words, the raw material or feedstock used to make the granules and/or their components should be renewable, repurposed and/or upcycled carbon resources rather than depleting whenever technically and economically practicable. As used herein, “BRC” (bio-renewable carbon) refers to carbon that is part of the earth's natural environment and non-fossil-based carbon. BRC are naturally occurring renewable, repurposed and/or upcycled carbon resources that can be replenished to replace the portion depleted by usage and consumption, either through natural reproduction, or other recurring processes in a finite amount of time (such as within a human lifetime). BRC would exclude carbon that comes from virgin crude oil. In some embodiments, the fragrance-containing granule of the present disclosure has a bio-renewable carbon (BRC) content of at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%, based on the weight of the granule.

The bio-renewable carbon (BRC) content can be determined using a method such as described in ASTM D6866-16 and ISO 16620. ASTM D6866-16 and ISO 16620-2 provide three different methods for determining the bio-renewable content of a solid, liquid, or gaseous composition. For example, the granules and/or consumer products of this disclosure can be dried and tested as a solid. As defined by ASTM D6866-16 and ISO 16620-1, the biobased carbon content is the amount of biobased carbon in the granules or consumer products as a percent of the weight (mass) of the total organic carbon therein. In particular, ASTM D6866-16 Method B measures the ratios of ¹⁴C/¹²C and ¹³C/¹²C in the composition using Accelerator Mass Spectrometry (AMS) and Isotope Ratio Mass Spectrometry (IRMS). Fossil based carbon contains essentially no ¹⁴C because its age is much greater than the 5,730 year half-life of ¹⁴C. Thus, the presence and level of ¹⁴C in a composition provides a direct measure of the amount of carbon that originated from a source other than a fossil fuel, i.e., the level of biobased carbon in the composition. If the biobased carbon contents of all raw materials in a mixture are known, it is also possible to calculate the biobased carbon content of the mixture according to ISO 16620-1.

In some embodiments, the granule of the present disclosure exhibits increased MIE value, preferably substantially increased MIE value, and/or lowered Kst value such that they can be safely processed, manipulated, stored and/or used (as compared to spray dried fragrance-containing powder). Kst, the dust deflagration index, is used to quantify the severity of a dust explosion. OSHA (Occupational Safety and Health Administration) classifies dusts into four dust hazard classes based on their Kst value as shown in Table 2 below. Preferably, the granule of the present disclosure has a Kst of dust hazard class St-1 (low explosivity risk) or St-0 (no explosivity risk), preferably St-0. It should be noted that the Kst is a statement of explosion violence only and gives no indication of the ignition sensitivity of a dust or the possibility of a dust explosion during the manipulation of the granules.

TABLE 2
Dust Hazard Classes

| Class | Kst value (bar · m/s) | Explosivity Risk |
|---|---|---|
| St-0 | 0 | Does not explode |
| St-1 | >0 to 200 | Weak explosion |
| St-2 | >200 to 300 | Strong explosion |
| St-3 | >300 | Very strong explosion |

Instead, the MIE is indicative of the likelihood of ignition of a dust cloud by discharges (e.g., static electricity or other such ignition sources), and is measured in millijoules (mJ) or joules (J). MIE of dust is defined as the lowest quantity of electrical energy (stored in a capacitor) which, when discharged over a spark gap, is just sufficient to ignite the most readily ignitable dust/air mixture in a series of tests, at atmospheric pressure, ambient temperature and lowest turbulence possible. In some embodiments, the granule of the present disclosure has a MIE value, measured according to ASTM E2019, of at least 1,000 mJ, at least 5,000 mJ, at least 7,500 mJ, or at least 10,000 mJ, more preferably more than 10,000 mJ.

In some embodiments, the granule may further comprise a fireproofing agent to minimize the explosion risk. Suitable examples of fireproofing agents are disclosed in WO 2003/043728A1 and WO 2019/170528A1, the disclosures of both are incorporated herein by reference. Other suitable fireproofing agents include sodium carbonate, zeolite, sodium sulphate, and mixtures thereof. Given that the fireproofing agents would be a supplemental solution to minimize the explosion risk, less of the fireproofing agents than disclosed in WO '728A1 and WO '528A1 would need to be used in the granules of the present disclosure.

### Process for Preparing the Granules

Inventors have discovered a process for preparing the fragrance-containing granule that is capable of delivering all of the benefits as noted herein. Essentially the solution is to print granules by using primarily biobased materials combined with fragrance oils to make an oil-in-water emulsion that is deposited as “dots” or “droplets” on a belt. The droplets are then dried to remove all or substantially all of the water to form the fragrance-containing granules. In some embodiments, the granule of the present disclosure is formed from a droplet obtainable (or obtained) from a deposition process comprising: (i) depositing an emulsion having a viscosity of from 1,000 m·Pas to 20,000 m·Pas at 25° C.; and (ii) optionally drying the deposited emulsion at a temperature of from 75° C. to 130° C., preferably from 80° C. to 125° C. In some embodiments, the emulsion has a viscosity of from 2,000 m·Pas to 10,000 m·Pas at 25° C. In some embodiments, the emulsion is deposited onto a belt (e.g., a conveyor belt). Without wishing to be bound by theory, it is important for the granules to be formed from a highly viscous emulsion because too much water in the emulsion will result in a low viscosity emulsion that would fail to deposit as discrete “dots” or “droplets” on the belt. However, too little water in the emulsion will result in a too high viscosity emulsion that would be difficult to pump and deposit onto the belt. Inventors have found a sweet spot in terms of viscosity ranges so that the emulsion is formulated with as little water as possible, yet still functional for the print process.

In some embodiments, the fragrance-containing granule of the present disclosure can be prepared according to the following method. There may be alternatives to the method, so there is no limitation regarding the way to obtain the granules. Thus, according to an embodiment, the fragrance-containing granules are obtained by a process as shown in FIG. 2. With reference to FIG. 2, the process may comprise the following steps:
(i) Preparing a water phase having high solid content (e.g., 68-70 wt %) and high viscosity (5,000-10,000 cP at 25° C.) by dissolving and/or dispersing the carbohydrate carrier with water,
(ii) Preparing an oil phase comprising the fragrance material (neat and/or encapsulated) and mixing the oil phase with the water phase of step (i) to obtain an oil-in-water emulsion (feed slurry in FIG. 2),
(iii) Mixing the emulsion of step (ii) with a high-shear disperser (IKA T50 Ultra-Turrax) to undergo high shear mixing (e.g., 13500 RPM) to reduce the oil droplet size to <5 microns,
(iv) Dispensing (using Depositor in FIG. 2) 3 mm diameter droplets or dots of the emulsion feed of step (iii) onto a conveyor belt at belt speed of 10 meter per minute, and
(v) Drying the droplets or dots by applying heat to them as they move along the conveyor belt to obtain the fragrance-containing granules of the present disclosure. Other drying method such as fluidized bed, or even a drying at room temperature can be suitable.

In some embodiments, the fragrance-containing granule of the present disclosure comprises a plurality of intra-granule air voids (i.e., air voids within the granule) formed by heating the granule to evaporate water from the granule. Preferably, the granule comprises less than 20%, 15%, 10%, 5%, 3%, or 1% water, based on the weight of the granule. In some embodiments, the granule is essentially free of water. As used herein, the term “air voids” refer to void spaces inside the granule in a porous or hollow form that are continuously kept after the granules are formed, preferably without being filled with other impurities. As the name suggest, air voids are filled with air and not other gases. The granule of the present disclosure has air voids that may have asymmetrical or irregular shapes having curved contours, or spherical or irregular spherical shapes (e.g., ellipses, crescents and the like). No observable difference in key performance criteria (e.g., dissolution rate) is expected between spherical air voids over non-spherical air voids. In some embodiments, the air avoids comprise a combination of spherical and non-spherical air avoids.

The air voids may have varying dimensions, for non-limiting example, anywhere between about 1 micron to about 3000 microns, for example when measured longitudinally. Without wishing to be bound by theory, it is believed that smaller air avoids (e.g., less than about 1000, 500, 400, 300, 200 or 100 microns or any dimensions therein between) may merge with other air avoids forming larger air avoids during the drying process. The resultant larger air voids (e.g., ≥100 microns, ≥200 microns, ≥300 microns, ≥400 microns, ≥500 microns, ≥600 microns, ≥700 microns, ≥800 microns, ≥900 microns or ≥1000 microns) are more desirable than smaller air voids to promote dissolution rate. Alternatively, the air voids of the present disclosure may comprise any combination of smaller and larger air voids, so long as they result in granules having the desired dissolution rate. In some embodiments, the fragrance-containing granule of the present disclosure comprises a plurality of intra-granule air voids having longitudinal dimension of at least 1 micron, at least 10 microns, at least 50 microns, at least 100 microns, at least 200 microns, at least 300 microns, at least 400 microns, or at least 500 microns. In some embodiments, the fragrance-containing granule of the present disclosure comprises a plurality of intra-granule air voids having longitudinal dimension of no more than 3000 microns, no more than 2500 microns, no more than 2000 microns, or no more than 1500 microns.

In some embodiments, the total volume of the air voids within the fragrance-containing granule (i.e., intra-granule air voids) is at least 10%, at least 15%, at least 20%, at least 25%, or at least 30%, based on the volume of the granule. In some embodiments, the total volume of the air voids within the granule is no more than 70%, no more than 65%, no more than 60%, no more than 55%, or no more than 50%, based on the volume of the granule. In some embodiments, the total volume of the air voids within the granule is in the range of from 15% to 70%, from 20% to 60%, or from 35% to 55%, based on the volume of the granule. Without being bound by theory, it is believed that granules with air voids, when formulated into animal litter, can be more easily wetted and therefore release the fragrances during use by the animal.

It is important to note that no air or other gas is intentionally added to the precursor materials in any steps used to make the air avoids enclosed in fragrance-containing granules of the present disclosure. Furthermore, as described above, the air voids found in the fragrance-containing granules are formed from water evaporation during the heating step, and not as a result of any fracturing during cooling step of the precursor materials from which the granules are produced. The combination of these different factors give rise to granules of the present disclosures having air voids that have notable different characteristics over any scented particles presently known.

### Consumer Products

In another aspect, the present disclosure relates to a consumer product comprising the fragrance-containing granule of the present disclosure. The consumer product is selected from the group consisting of powder laundry detergent, powder automatic dishwasher detergent, animal litter, bath salt, room deodorizer, room de-humidifier, powder fabric bleach, powdered soap and powdered cleaner. In some embodiments, the consumer product is an animal litter. Preferably the animal litter has one or more characteristics selected from the group consisting of enhanced malodor control, lower tracking and lower dusting as compared to an animal litter comprising a spray dried fragrance-containing powder. Without wishing to be bound by theory, it is believed that the retention of more top notes in the granules (compared with traditional spray dried fragrance-containing powders) means that those top notes can get into the air in higher volume to counteract malodor materials (also high volatile materials). Spray dried powders are fine small particle size powders that can stick to an animal's paw which can then be “tracked” out of the litter box and onto surrounding surfaces. This phenomenon also has the effect of fragrancing the animal's paws which is undesirable as it reminds the pet owner that the animal has just visited the litter tray. As mentioned before the spray dried powder has very small particle size which means it can create dust when being added and blended in a factory but also for the consumer when pouring from a box or bag into a litter box. Dust is not only unsightly and settles on surfaces outside the box, prolonged inhalation exposure can cause health issues to animals and humans that are regularly exposed.

In a preferred embodiment, the animal litter is a domestic animal litter (e.g., cat litter, rabbit litter, gerbil litter, and dog litter, especially cat litter). According to this embodiment, the consumer product is an animal litter comprising a major proportion of particulate material and a minor proportion of the fragrance-containing granule of the present disclosure. Preferably, the animal litter comprises the fragrance-containing granule present in an amount ranging from about 0.01 wt % to about 5.0 wt %, more preferably from 0.04 wt % to 0.20 wt %, relative to the total weight of the animal litter, and the particulate material present in an amount ranging from about 95 wt % to about 99.99 wt %, more preferably from 99.8 wt % to 99.96 wt %, relative to the total weight of the animal litter. In some embodiments, the particulate material has a bulk density of from about 0.35 g/mL to about 1.40 g/mL. In some embodiments, the cat litter comprises a particulate material and a fragrance-containing granule, and the ratio of the bulk density of the particulate material to the bulk density of the fragrance-containing granule is no more than 4:1. Clay based cat litters have a bulk density of from about 1.0 to about 1.5, so ideally the granule of the present disclosure has a similar density but must not be less than a quarter of the cat litter's density to prevent segregation in the product.

In some embodiments, the animal litter of the present disclosure further comprises at least one performance-enhancing actives that improve the function and/or properties of the animal litter. Preferably the performance-enhancing active is selected from the group consisting of antimicrobials, odor absorbers, odor inhibitors, binders that promote clumping, health indicating materials, non-stick release agents, light-weighting minerals, miller materials, and combinations thereof. The active(s) can be added in any useful amount depending on the active and its use. Typically, the performance-enhancing active can be present in the animal litter in an amount of from about 0.01 wt % to about 5 wt %, preferably from about 0.05 wt % to about 2 wt %, relative to the total weight of the animal litter.

In some embodiments, the animal litter comprises the fragrance-containing granule and the particulate material, and the fragrance-containing granule and the particulate material have a particle size dispersity index (PSDI) of less than 0.2 (St. Dev/Mean). This means that the fragrance-containing granule and the particulate material are substantially or completely uniformly blended. PSDI can be measured by dispersing a sample of the granules and particulate material into distilled water and then measuring with Malvern Nano-S. Further details of the method are described in <https://www.ncbi.nlm.nih.gov/pmc/articles/PMC5035303/>, the content of which is incorporated herein by reference. It is yet a further advantage that the fragrance-containing granule and the particulate material of the present disclosure exhibit a polydispersity index of ≤0.2 (St. Dev/Mean). This means that the granules and the particulate material of the present disclosure have a substantially monodispersed particle size distribution. Without wishing to be bound by theory, it is believed that by having a more monodispersed particle size distribution, plus the capability to modulate particle size, the granules and the particulate material will result in a more favorable uniform distribution in the animal litter. As a result, during use the fragrance-containing granules of the present disclosure will exhibit a more even distribution with each scope of the animal litter.

It should be noted that the animal litter of the present disclosure is useful for a variety of purposes other than just as an animal litter. For example, the animal litter can be used to treat water, treat wastewater, manage liquid spills, and the like. Other non-animal litter applications are also contemplated for the fragrance-containing granule of the present disclosure. The fragrance-containing granule of the present disclosure can be used in any situations where imparting a fragrance to the consumer product is desired, such as but not limited to, powder laundry detergent, powder automatic dishwasher detergent, bath salt, room deodorizer, room de-humidifier, powdered fabric bleach, powdered soap, and powdered cleaner.

In another aspect, the present disclosure provides a method of producing animal litter. The method comprises: (i) providing a particulate material comprising an absorbent material and optionally at least one performance-enhancing active selected from the group consisting of antimicrobials, odor absorbers, odor inhibitors, binders that promote clumping, health indicating materials, non-stick release agents, light-weighting minerals, miller materials, and combinations thereof; and (ii) mixing the fragrance-containing granule of the present disclosure and the particulate material; wherein the particulate material has an average particle size ranging from 400 μm to 4 mm. Generally, the granules and the particulate material can be combined using any suitable methods known in the art, e.g, stirring, dry blending, and the like. The order of addition of the granules and the particulate material can be any order suitable for producing the animal litter.

Generally, the animal litter is placed in a litter box or other suitable container and the animal is allowed to deposit its waste (e.g., urine or feces) on the animal litter. If desirable, the animal litter can be placed in contact with the waste after the waste is deposited, e.g., on a lawn.

In another aspect, the present disclosure provides an animal litter box comprising the animal litter of the present disclosure and a device suitable for containing animal litter and suitable for use by an animal when excreting animal waste. Suitable devices are known in the art and available commercially, e.g., the litter boxes disclosed in US2009/0250014A1, US20090272327A1, US2009000560A1, US20070277740A1 and U.S. Pat. No. 7,628,118.

In another aspect, the present disclosure provides a kit suitable for containing animal litter useful for managing waste, particularly animal waste. The kit comprises in separate containers in a single package or in separate containers in a virtual package, as appropriate for the kit component, the animal litter of the present disclosure and one or more of (1) a device suitable for containing the animal litter and suitable for use by an animal when excreting animal waste, e.g., a litter box; (2) a device suitable for handling animal waste that has been deposited on the animal litter, e.g., a scoop for removing animal feces from a litter (e.g., U.S. Pat. No. 7,523,973) or a rake suitable for arranging an animal litter in a litter box or other container; (3) a different animal litter, e.g., a different animal litter suitable for creating a mixture of the animal litter of the present disclosure and such different animal litter; (4) instructions for how to use the animal litter of the present disclosure to manage waste, particularly animal waste; and (5) instructions for how to dispose of the animal litter of the present disclosure (e.g., how to dispose of the litter in an environmentally friendly manner, particularly after it has been used).

When the kit comprises a virtual package, the kit is limited to instructions in a virtual environment in combination with one or more physical kit components. The kit may contain the kit components in any of various combinations and/or mixtures. In one embodiment, the kit contains a package containing the animal litter of the present disclosure and a scoop suitable for removing animal waste from the animal litter.

In another aspect, the present disclosure provides a package comprising a material suitable for containing animal litter of the present disclosure and a label affixed to the package containing a word or words, picture, design, acronym, slogan, phrase, or other device, or combination thereof, that indicates that the contents of the package contain animal litter of the present disclosure, e.g., information about the animal litter's enhanced properties, including effective malodor control or other physical, functional or related properties.

In another aspect, the present disclosure provides a method of imparting a fragrance to animal litter. The method comprises admixing: (i) from about 0.02 wt % to about 5 wt % relative to the total weight of the animal litter of a plurality of fragrance-containing granules of the present disclosure; and (ii) from about 99.98 wt % to about 95 wt % relative to the total weight of the animal litter of a particulate material. Preferably, the animal litter exhibits one or more characteristics selected from the group consisting of enhanced malodor control, low tracking, and low dusting as compared to an animal litter comprising a spray dried fragranced powder.

Many aspects and embodiments have been described above and are merely exemplary and not limiting. After reading this specification, skilled artisans appreciate that other aspects and embodiments are possible without departing from the scope of the invention. All publications cited herein are incorporated by reference in their entirety for all purposes.

### Test Methods

The following test methods set forth must be used in order that the invention described and claimed herein may be more fully understood.

### Test Method 1: Skeletal Density Test (i.e., Porosity Test)

The Porosity Test is used to measure the relative volume of porosity contained within the internal structure of granule, (i.e., intra-granule porosity). The principle of Applicant's Porosity Test follows that of published International Standard ISO 15901-01: Evaluation of pore size distribution and porosity of materials by mercury porosimetry and gas adsorption-Part 1: Mercury Porosimetry. Porosity falls into two categories: inter-granule (voids in-between granules) and intra-granule porosity (pores within granules). The current method is used to measure the intra-granule porosity. The details of the method, as adapted to the present disclosure, are as follows.

A granule sample of about 2 cm³ volume with granule size from 300 μm to 600 μm by sieve classification is loaded into the Penetrometer assembly having a suitable bulb and stem assembly to ensure greater than 25% and less than 75% stem volume usage over the pressure range specified in part 3. The sample assembly is then evacuated to remove gas from pores.

Dry nitrogen is introduced into the evacuated measuring cell in a controlled manner to increase the pressure (either in stages, continuously or by step-wise pressurization) according to the proper equilibration conditions for mercury entering the pores and with precision required for the particular pores size range of interest, covering at least up to 0.2 MPa, corresponding to 6 μm pore size diameter. Pressure and corresponding volume of mercury intruded can be recorded either graphically or via a computer. When the maximum required pressure has been reached, the pressure is reduced to ambient and the sample holder is transferred to the high-pressure unit.

In the high pressure unit, pressure is increased via intrusion of mercury (as a hydraulic fluid) by step-wise pressurization according to the proper equilibration conditions for mercury entering the pores, with precision required for the particular pores size range of interest, covering at least up to 400 MPa, corresponding to 3 nm pore diameter. As a consequence, mercury is pressed into the pore system and the decreasing length of the mercury column is measured as a function of pressure. Pressure and corresponding volume of mercury intruded can be recorded via a computer.

The pressure exerted is inversely proportional to the clear width of the pore entrance. For pores of cylindrical shape the Washburn equation gives the relation between pressure and diameter: dₚ=−4γ cos θ/P, in which dₚ is pore size diameter, γ is surface tension of mercury [Nm⁻¹], θ is contact angle, and P is the intrusion pressure. Generally used values for surface tension and contact angle of mercury are 480 mN·m⁻¹ and 140°, respectively. Using the Washburn equation the pressure readings are converted to pore size diameter. The intruded volume related to sample mass as ordinate in dependence of the pore diameter as abscissa is plotted to give the pore volume distribution.

The cumulative pore volume distribution includes both interstitial and intra-granule porosity. Within the bounds of the present disclosure, the threshold intra-granule pore size has been determined using a differential distribution analysis: 30 μm is cut-off pore size; pores larger than 30 μm are considered as inter-granule; and pores smaller than 30 μm is considered intra-granule. The intra-granule porosity is calculated by intra-granule pore volume divided by the sum of the intra-granule pore volume and the solid volume of the granule sample. The solid volume of the sample is the sample volume minus the total pore volume.

### Test Method 2: Bulk Density Test

The bulk density of a given portion of a material (e.g., granules, particulate material, etc.) is the mass of the given portion of the material divided by its total volume. The bulk density of the material can be measured by using the following steps: (i) put an empty 100 mL graduated cylinder, readable to 1 mL, on a balance; (ii) tare the balance with the empty graduated cylinder on it; (iii) introduce into the graduated cylinder, without compacting, the material up to the 100 mL line; (iv) weigh the graduated cylinder (with the material in it) to obtain the mass of the material in the cylinder; (v) secure the graduated cylinder (with the material in it) on a mechanical tapper for 1000 taps, which aims to reduce the volume the material takes up in the cylinder; (vi) record the volume of the material in the graduated cylinder after tapping; and (vii) divide the mass of the material by the volume of the material (after tapping) to obtain the bulk density of the material.

### Test Method 3: Olfactive Test

This test evaluates the olfactive performance of the fragrance-containing granule of the present disclosure vs. a comparative spray dried fragrance-containing powder on the perception of the fragrance profile, specifically the fragrance intensity derived from the top notes. At the testing facility, 1 g of the fragrance-containing granule and 1 g of the comparative spray dried fragrance-containing powder are introduced into respective containers. 100 mL of room temperature (25° C.) water are added into the container to dissolve the granule and the powder respectively. The granule and powder samples are dissolved in water under agitation for 2 minutes. The containers with the water solutions of samples are sealed with lids and presented to evaluators. Evaluators are selected from individuals who are either trained to evaluate fragrances according to the scales below or who have experience of fragrance evaluation in the industry. Typically, around 6-10 panelists are used in the evaluation. The panelists are asked to give a score on a scale of 0 to 5 for perceived fragrance intensity of the top notes, with 0 being the weakest and 5 being the strongest.

### Test Method 4: MIE Test

The purpose of the MIE Test is to determine the minimum energy of an electrical spark that will result in ignition of a dust cloud carried out in a modified Hartmann vertical tube. This is a vertical tube, open at the top, of transparent plastic and has a volume of about 1.3 L. The tests are performed according to the ASTM E2019 Standard Test method. All measurements are performed by Dekra US, Atlanta, Georgia.

### EXAMPLES

The following non-limiting examples are provided to further illustrate the present invention and are not to be construed as limitations of the invention, as many variations of the present invention are possible without departing from its spirit or scope.

### Example 1—Preparation of Fragrance-Containing Granules

The composition of the fragrance-containing granule is shown in Table 3 below. Into a suitable vessel, the prescribed amount of water was added and it was heated to about 60° C. With continuous mixing, sodium sulfate was added and mixed until it was fully dissolved. Capsul® modified starch (starch sodium octenyl succinate, available from Ingredion) was slowly added to minimize clumping, and mixing was continued until it was fully dissolved. The resultant solution was cooled to about 30° C. The viscosity of the solution was checked with the Brookfield Viscometer using spindle #7 at 60 RPM. The viscosity value was high as 30,000 cPs.

In a separate vessel, the prescribed amount of a neat fragrance oil was added. While the homogenizer, IKA Turrax® T-50 (available from IKA-Werke GmbH & Co. KG, Staufen, Germany), was immersed in the starch and sodium sulfate solution, the neat fragrance oil was added slowly into the solution until the neat fragrance vessel was empty. Continuous high shearing at 13500 RPM for a minimum of 5 minutes. The viscosity of the resulting oil-in-water emulsion was checked with the Brookfield viscometer using spindle #7 at 60 RPM. The viscosity value was high as 30,000 cPs. Also, the particle size distribution of the oil droplets in the emulsion was checked. A target Mean of <10 micron and a target Mode of <3 micron was achieved.

While continuously mixing the emulsion, an aqueous microcapsule slurry containing an encapsulated fragrance was slowly added into the emulsion at the prescribed amount. Again, viscosity of the resulting emulsion was checked with the Brookfield Viscometer using spindle #4 at 60 rpm. The viscosity value was high as 10,000 cPs.

Finally, while mixing, rice starch was added into the emulsion at the prescribed amount to generate the emulsion feed (i.e., feed slurry) to be used in the printing process as depicted in FIG. 2. Viscosity of the resulting emulsion was checked again using spindle #4 at 60 rpm. The viscosity value was high as 15,000 cPs.

As shown in FIG. 2, the emulsion feed (i.e., feed slurry) generated above was deposited onto a conveyor belt as 3 mm diameter droplets or dots. The conveyor belt moved at belt speed of 5 meter per minute. The dots were dried in the drying chamber with infrared light to generate the fragrance-containing granules.

TABLE 3
Composition of the Granule (wet)

| Ingredients | Wet (g) | Weight (%) |
|---|---|---|
| Water | 1597.5 | 15.9 |
| Capsul ® modified starch | 1880.2 | 18.7 |
| Sodium sulfate | 340 | 3.4 |
| Neat fragrance | 2720 | 27.1 |
| Microcapsule slurry | 2179.49 | 21.7 |
| Rice starch | 805.12 | 8.0 |
| Glycerin | 511.83 | 5.2 |
| Total | 10034.14 | 100% |

### Example 2—Preparation of Comparative Spray Dried Fragrance-Containing Powders

A comparative spray dried fragrance-containing powder was prepared according to Table 3 in Example 1, except that an additional 4650 grams of water was used to reduce the viscosity of the emulsion to <500 cPs. The emulsion was then spray dried to generate the spray dried fragrance-containing powder.

### Example 3—MIE of Fragrance-Containing Granules Vs Comparative Spray Dried Fragrance-Containing Powders

Sample A is the fragrance-containing granule prepared according to Example 1, and Sample B is the comparative spray dried fragrance-containing powder prepared according to Example 2. The MIE for Samples A and B are determined in accordance with the Test Method 4 (MIE Test). The results of the evaluation are summarized in Table 4 below.

TABLE 4
MIE Results

| | Minimum Ignition Energy (mJ) |
|---|---|
| Sample A | >10,000 |
| Sample B | 3-5 |

The results show that Sample B has a very low MIE indicating that it is extremely sensitive to ignition from any electrical source. In contrast, Sample A, which is the fragrance-containing granule of this disclosure, has a very high MIE which means that it has extremely low sensitivity to ignition and therefore has low explosion risk during production and handling.

### Example 4—Preparation of Fragrance-Containing Granule with High Density

For certain applications (e.g., animal litter) where a high bulk density and a high skeletal density are preferred, an inorganic density enhancing additive can be added into the composition of the granule.

The composition of the fragrance-containing granule is shown in Table 5 below. In a suitable vessel, the prescribed amount of water was added and it was heated to about 60° C. With continuous mixing, Citrem N12 (citric acid esters of monoglycerides) was added and mixed until it was fully dissolved. Sodium sulfate was then added and mixed until fully dissolved. Capsul® modified starch and gum Arabic were slowly added to minimize clumping, and mixing was continued until they were fully dissolved. The resultant solution was cooled to about 30° C. The viscosity of the solution was checked with the Brookfield Viscometer using spindle #7 at 60 RPM. The viscosity value was about 100 cPs.

In a separate vessel, the prescribed amount of a neat fragrance oil and a Methocel K99 (hydroxypropyl methylcellulose) were added. While the homogenizer, IKA Turrax® T-50 (available from IKA-Werke GmbH & Co. KG, Staufen, Germany), was immersed in the solution (containing Capsul® modified starch, gum Arabic, Citrem N12 and sodium sulfate), the neat fragrance oil/Methocel K99 mixture was added slowly into the solution until the vessel (containing the neat fragrance oil/Methocel K99 mixture) was empty. Continuous high shearing at 13500 RPM for a minimum of 5 minutes. The viscosity of the resulting oil-in-water emulsion was checked with the Brookfield viscometer using spindle #7 at 60 RPM. The viscosity value was about 1,000 cPs. Also, the particle size distribution of the oil droplets in the emulsion was checked. A target Mean of <3 micron and a target Mode of <3 micron was achieved.

While continuously mixing the emulsion, titanium dioxide was slowly added into the emulsion at the prescribed amount. Finally, while mixing, rice starch was added into the emulsion at the prescribed amount to generate the emulsion feed (i.e., feed slurry) to be used in the printing process as depicted in FIG. 2. Again, viscosity of the resulting emulsion was checked with the Brookfield Viscometer using spindle #4 at 60 rpm. The viscosity value was high as 5,600 cPs.

As shown in FIG. 2, the emulsion feed (i.e., feed slurry) generated above was deposited onto a conveyor belt as 3 mm diameter droplets or dots. The conveyor belt moved at belt speed of 5 meter per minute. The dots were dried in the drying chamber with infrared light to generate the fragrance-containing granules of the present disclosure.

TABLE 5
Composition of the Granules with High Density (wet)

| Ingredients | Wet (g) | Weight (%) |
|---|---|---|
| Water | 4688 | 34.0 |
| Citrem N-12 | 18.2 | 0.1 |
| Sodium Sulfate | 634.8 | 4.6 |
| Capsul ® modified starch | 571.9 | 4.1 |
| Gum Arabic | 571.9 | 4.1 |
| Dyes | 28.1 | 0.2 |
| Methocel K99 | 183.1 | 1.3 |
| Neat fragrance | 3660.6 | 26.6 |
| Titanium Dioxide | 1715.7 | 12.4 |
| Rice Starch | 1715.7 | 12.4 |
| Total | 13788.0 | 100% |

### Example 5—Preparation of Fragrance-Containing Granule

The composition of the fragrance-containing granule is shown in Table 6 below. In a suitable vessel, the prescribed amount of water was added and it was heated to about 60° C. With continuous mixing, Citrem N12 (citric acid esters of monoglycerides) was added and mixed until it was fully dissolved. Sodium sulfate was then added and mixed until fully dissolved. Purity Gum® 2000 modified starch and gum Arabic were slowly added to minimize clumping, and mixing was continued until they were fully dissolved. The resultant solution was cooled to about 30° C. The viscosity of the solution was checked with the Brookfield Viscometer using spindle #7 at 60 RPM. The viscosity value was about 100 cPs.

In a separate vessel, the prescribed amount of a neat fragrance oil was added. While the homogenizer, IKA Turrax® T-50 (available from IKA-Werke GmbH & Co. KG, Staufen, Germany), was immersed in the solution (containing Purity Gum® 2000 modified starch, gum Arabic, Citrem N12 and sodium sulfate), the neat fragrance oil was added slowly into the solution until the vessel (containing the neat fragrance oil) was empty. Continuous high shearing at 13500 RPM for a minimum of 5 minutes. The viscosity of the resulting oil-in-water emulsion was checked with the Brookfield viscometer using spindle #7 at 60 RPM. The viscosity value was high as 1,000 cPs. Also, the particle size distribution of the oil droplets in the emulsion was checked. A target Mean of <3 micron and a target Mode of <3 micron was achieved.

While continuously mixing the emulsion, a potato starch and titanium dioxide were slowly added into the emulsion at the prescribed amounts. Finally, while mixing, rice starch was added into the emulsion at the prescribed amount to generate the emulsion feed (i.e., feed slurry) to be used in the printing process as depicted in FIG. 2. Again, viscosity of the resulting emulsion was checked with the Brookfield Viscometer using spindle #4 at 60 rpm. The viscosity value was high as 5,000 cPs.

As shown in FIG. 2, the emulsion feed (i.e., feed slurry) generated above was deposited onto a conveyor belt as 3 mm diameter droplets or dots. The conveyor belt moved at belt speed of 5 meter per minute. The dots were dried in the drying chamber with infrared light to generate the fragrance-containing granules of the present disclosure.

TABLE 6
Composition of the Granules (wet)

| Ingredients | Wet (g) | Weight (%) |
|---|---|---|
| Water | 3900 | 39.00 |
| Citrem N-12 | 30 | 0.3 |
| Sodium Sulfate | 198 | 1.98 |
| Purity Gum ® 2000 | 892 | 8.92 |
| Gum Arabic | 1177 | 11.77 |
| Fragrance Oil | 2440 | 24.4 |
| Potato Starch | 315 | 3.15 |
| Titanium Dioxide | 350 | 3.5 |
| Rice Starch | 698 | 6.98 |
| Total | 10000 | 100 |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination.

1. A fragrance-containing granule comprising, by weight based on the weight of the granule,
(a) greater than 35% of a fragrance material;
(b) from 1% to 30% of an inorganic density enhancing additive; and
(c) from 1% to 50% of a carbohydrate carrier;
wherein the granule has a skeletal density of from 1.00 g/mL to 1.40 g/mL and a bulk density of from 0.20 g/mL to 1.40 g/mL, preferably from 0.30 g/mL to 0.60 g/mL.

2. The granule of claim 1, wherein the granule has:
(i) water activity (a_{w}) of <0.6 at 25° C.; and/or
(ii) an average granular weight of 1 mg to 10 mg, or 3 mg to 7 mg; and/or
(iii) an Average Mean Diameter in the range of 1 mm to 5 mm, or 2 mm to 3 mm.

3. The granule of claim 1, wherein the granule comprises one or more intra-granule air voids formed by heating the granule to evaporate water from the granule, preferably the air avoids comprises a combination of spherical and non-spherical air avoids.

4. The granule of claim 1, wherein the inorganic density enhancing additive is selected from the group consisting of titanium dioxide, talc, silicon dioxide, calcium carbonate, calcium silicate, sodium silicate, zinc oxide, magnesium oxide, magnesium silicate, magnesium aluminum silicate, clay (e.g., bentonite clay), trisodium phosphate, and combinations thereof, preferably the inorganic density enhancing additive is titanium dioxide and/or calcium silicate.

5. The granule of claim 1, wherein the granule has a bio-renewable carbon (BRC) content of at least 50%, at least 55%, at least 60%, at least 65%, at least 70%, at least 75%, at least 80%, at least 85%, at least 90% or at least 95%, based on the weight of the granule.

6. The granule of claim 1, wherein the granule has a prolonged and/or stronger perceived intensity of the fragrance profile, particularly characters attributable to a high volatile fragrance material having a vapor pressure greater than 0.1 Torr (0.0133 kPa) at 25° C. (i.e., top notes), compared with a comparative spray dried fragrance-containing powder according to the Olfactive Test as described in this disclosure, preferably the high volatile fragrance material is selected from the group consisting of butyl acet, eth-2-meth buty, iso amyl acet, manzanate, prenyl acet, orange oil, acet C-6, iso amyl buty, allyl caproate, and combinations thereof.

7. The granule of claim 1, wherein the carbohydrate carrier comprises starch, modified starch, polysaccharide, cellulose, pectin, or a mixture thereof, preferably the carbohydrate carrier comprises a starch selected from the group consisting of corn starch, potato starch, rice starch, tapioca starch, and mixtures thereof, preferably the carbohydrate carrier comprises a modified starch.

8. The granule of claim 1, wherein the granule is formed from a droplet obtainable from a deposition process comprising: (i) depositing an emulsion having a viscosity of from 1,000 m·Pas to 20,000 m·Pas, preferably from 2,000 m·Pas to 10,000 m·Pas, at 25° C.; and (ii) optionally drying the deposited emulsion at a temperature of from 75° C. to 130° C., preferably from 80° C. to 125° C.

9. The granule of claim 1, wherein the fragrance material comprises a neat fragrance.

10. The granule of claim 1, wherein the granule exhibits an increased minimum ignition energy (MIE) value measured according to ASTM E2019, and/or a lowered Kst value as compared with a spray dried fragrance-containing powder, preferably the granule exhibits a MIE value (measured according to ASTM E2019) of ≥1,000 mJ, ≥5,000 mJ, ≥7,500 mJ, or ≥10,000 mJ, more preferably >10,000 mJ; and/or a Kst value of dust hazard class St-1 (low explosivity risk) or St-0 (no explosivity risk), preferably St-0.

11. A consumer product comprising the granule of claim 1, wherein the consumer product is selected from the group consisting of powder laundry detergent, powder automatic dishwasher detergent, animal litter, bath salt, room deodorizer, room de-humidifier, powder fabric bleach, powdered soap and powdered cleaner, preferably the consumer product is animal litter, more preferably the animal litter has one or more characteristics selected from the group consisting of enhanced malodor control, lower tracking and lower dusting as compared to an animal litter comprising a spray dried fragrance-containing powder.

12. The consumer product of claim 11, wherein the consumer product is animal litter, preferably cat litter, and further comprises a particulate material having a bulk density of from 0.35 g/mL to 1.40 g/mL, preferably the cat litter has a ratio of the bulk density of the particulate material to the bulk density of the fragrance-containing granule of no more than 4:1.

13. The consumer product of claim 11, wherein the fragrance-containing granule and the particulate material have a particle size dispersity index (PSDI) of <0.2 (St. Dev/Mean), preferably the granule and the particulate material are uniformly blended, preferably the particulate material comprises an absorbent material and has an average particle size ranging from 400 μm to 4.0 mm, and optionally at least one performance-enhancing active selected from the group consisting of antimicrobials, odor absorbers, odor inhibitors, binders that promote clumping, health indicating materials, non-stick release agents, light-weighting minerals, miller materials, and combinations thereof.

14. A method of producing animal litter, comprising:
(i) providing a particulate material comprising an absorbent material and optionally at least one performance-enhancing active selected from the group consisting of antimicrobials, odor absorbers, odor inhibitors, binders that promote clumping, health indicating materials, non-stick release agents, light-weighting minerals, miller materials, and combinations thereof; and
(ii) mixing the granule of any one of claims 1 to 10 and the particulate material;
wherein the particulate material has an average particle size ranging from 400 μm to 4 mm.

15. A method of imparting a fragrance to animal litter, comprising admixing:
(i) from 0.02 wt % to 5 wt %, relative to the total weight of the animal litter, of the granule of any one of claims 1 to 10, and
(ii) from 99.98 wt % to 95 wt %, relative to the total weight of the animal litter, of a particulate material,
preferably the animal litter exhibits one or more characteristics selected from the group consisting of enhanced malodor control, lower tracking, and lower dusting as compared to an animal litter comprising a spray dried fragranced powder.
